(19) United States
(12) Patent Application Publication
(10) Pub. No.: US 2025/0088573 A1
(43) Pub. Date: Mar. 13, 2025

(54) NETWORKING DEVICE VISUAL INDICATOR SIMULATION

(71) Applicant: Juniper Networks, Inc., Sunnyvale, CA (US)

(72) Inventors: Sandip Kumar Ghosh, Bangalore (IN); Raja Kommula, Cupertino, CA (US); Raj Yavatkar, Los Gatos, CA (US)

(21) Appl. No.: 18/825,732

(22) Filed: Sep. 5, 2024

(30) Foreign Application Priority Data
Sep. 11, 2023 (IN) 202341060923

(51) Int. Cl. H04L 67/75; H04L 41/22

(52) U.S. Cl. CPC H04L 67/75; H04L 41/22

(57) ABSTRACT

In some examples, a computing system includes memory and one or more programmable processors in communication with the memory. The computing system is configured to visual indicator status information of a network device, wherein the visual indicator status information includes information for one or more virtual visual indicators of the network device to indicate a state of the network device or a state of one or more links associated with the network device. The computing system is further configured to generate, based on the visual indicator status information of the network device, a user interface that includes a representation of the network device and one or more virtual visual indicators indicating the state of the network device or the state of one or more links associated with the network device. The computing system is further configured to output, for display on a display device, the user interface.

This application claims the benefit of India Provisional Patent Application No. 202341060923, filed 11 Sep. 2023, the entire contents of which is incorporated herein by reference.

### TECHNICAL FIELD

This disclosure relates to computer networks and, more specifically, to improving energy efficiency in computer networks.

### BACKGROUND

In a typical cloud data center environment, there is a large collection of interconnected servers that provide computing and/or storage capacity to run various applications. A data center may comprise a facility that hosts applications and services for subscribers, i.e., customers of data center. The data center may, for example, host all of the infrastructure equipment, such as networking and storage systems, redundant power supplies, and environmental controls. In a typical data center, clusters of storage servers and application servers (compute nodes) are interconnected via high-speed switch fabric provided by one or more tiers of physical network switches and routers. More sophisticated data centers provide infrastructure spread throughout the world with subscriber support equipment located in various physical hosting facilities.

As data centers become larger, energy usage by the data centers increases. Some large data centers require a significant amount of power (e.g., around 100 megawatts), which is enough to power many homes (e.g., around 80,000). Data centers may also run application workloads that are compute and data intensive, such as crypto mining and machine learning applications, and consume a significant amount of energy. Customers of data centers and data center providers themselves are pushing for more energy efficient data centers and/or applications. To be more energy efficient, conventional data centers may source some of its energy from renewable energy sources. However, the configuration of data centers and/or the applications that run on the data centers are constantly changing and these conventional data centers are unable to dynamically increase its energy efficiency.

Traditional data centers may include a plurality of network devices that each include a plurality of visual indicators. These visual indicators may indicate information corresponding to a configuration and/or state of the plurality of network devices, configuration/state of components of the network devices (e.g., field replaceable units (FRUs), fan trays, power supply modules, storage drives, etc.) and/or network links of the network devices, such as a status of one or more network links (e.g., active/inactive, connectivity issues, etc.), that may provide information that assists network administrators in understanding the state of the network links of the network devices, debugging connectivity issues, etc.

Visual indicators may comprise light-emitting diodes (LEDs) and/or other kinds of lights that draw power when activated. A single data center may include tens, hundreds, or even thousands of network devices. Further, each individual network device may include dozens of visual indicators. While each visual indicator may only draw a minimal amount of power (e.g., often less than 0.5 watts), the substantial number of visual indicators within a datacenter may result in a significant amount of power consumption.

### SUMMARY

In general, techniques are described for generating graphical representations of a network device and one or more visual indicators associated with the network device. A network device may obtain information associated with a state of the network device and/or links associated with the network device and generate, based on the state information, visual indicator status information for virtual or simulated visual indicators of the network device to virtually indicate a state of the network device and/or a state of one or more links associated with the network device. Visual indicator status information may include, for example, a particular color or other characteristic corresponding to a particular state of the network device and/or particular state of a link to be displayed by a graphical representation of a visual indicator (referred to herein as a “virtual visual indicator”). In some examples, the network device may generate the visual indicator status information for virtual visual indicators even when physical visual indicators are not physically present on the network device. For example, the network device may generate visual indicator status information for a virtual visual indicator depicting the state for a port of the network device, where the port does not include a physical visual indicator or a physical visual indicator for the port is deactivated.

A controller may obtain the visual indicator status information from the network device and generate, based on the visual indicator status information, a graphical user interface (GUI) that includes a visual representation of the network device and one or more virtual visual indicators associated with the network device that indicate, for example, the state of the network device and/or links associated with the network device.

The techniques of this disclosure may provide one or more improvements to the computer-related field of computer networking that are integrated within a practical application. For example, the generation of visual representations of virtual visual indicators may allow administrators to obtain the status of a network device and/or links associated with the network device without utilizing physical visual indicators. By utilizing virtual visual indicators instead of physical visual indicators, network devices may be designed and manufactured without including any physical visual indicators, or physical visual indicators of the network devices may be deactivated, which reduces power consumption by the network device. The removal of physical visual indicators from design requirements may also enable the network device to be constructed with improved space for the intake of air into the network device for improved cooling and/or allow for the inclusion of more network ports (e.g., using the space ordinarily occupied by physical visual indicators for cooling and/or additional network ports instead). In another example, the use of virtual visual indicators may enable a network administrator to view the status of a network device without needing to physically view the device. For instance, a network administrator may be able to view the status of a network device from an entirely different location from the network device to provide remote monitoring and/or troubleshooting of the network device. In yet another example, by implementing virtual visual indicators instead of physical visual indicators, the virtual visual indicator may be customized to display any type of characteristic (e.g., color) corresponding to a particular state of the network device and is not limited to the physical characteristics and/or constraints of the physical visual indicator.

In one example, a computing system includes memory and one or more programmable processors in communication with the memory, wherein the one or more programmable processors are configured to obtain visual indicator status information of a network device, wherein the visual indicator status information includes information for one or more virtual visual indicators of the network device to indicate a state of the network device or a state of one or more links associated with the network device; generate, based on the visual indicator status information of the network device, a graphical user interface that includes a visual representation of the network device and one or more virtual visual indicators indicating the state of the network device or the state of one or more links associated with the network device; and output, for display on a display device, the graphical user interface

In another example, a method includes obtaining, by a computing system, visual indicator status information of a network device, wherein the visual indicator status information includes information for one or more virtual visual indicators of the network device to indicate a state of the network device or a state of one or more links associated with the network device; generating, by the computing system based on the visual indicator status information of the network device, a graphical user interface that includes a visual representation of the network device and one or more virtual visual indicators indicating the state of the network device or the state of one or more links associated with the network device; outputting, by the computing system and for display on a display device, the graphical user interface.

In yet another example, non-transitory computer-readable storage media includes instructions configured to cause processing circuitry to obtain visual indicator status information of a network device, wherein the visual indicator status information includes information for one or more virtual visual indicators of the network device to indicate a state of the network device or a state of one or more links associated with the network device; generate, based on the visual indicator status information of the network device, a graphical user interface that includes a visual representation of the network device and one or more virtual visual indicators indicating the state of the network device or the state of one or more links associated with the network device; and output, for display on a display device, the graphical user interface.

The details of one or more examples of this disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example network system having computing infrastructure, in accordance with one or more techniques of this disclosure.

FIG. 2 is a block diagram illustrating an example network device, in accordance with one or more techniques of this disclosure.

FIG. 3 is a block diagram illustrating an example controller, in accordance with one or more techniques of this disclosure.

FIG. 4A is a conceptual diagram of an example graphical user interface that includes a representation of a server and virtual visual indicators, in accordance with one or more techniques of this disclosure.

FIG. 4B is a conceptual diagram of another example graphical user interface that includes a representation of a rack of network devices and virtual visual indicators, in accordance with one or more techniques of this disclosure.

FIG. 5 is a flow diagram illustrating an example operation for providing a graphical user interface that includes virtual visual indicators, in accordance with one or more techniques in this disclosure.

FIG. 6 is a flow diagram illustrating another example operation for providing a graphical user interface that includes virtual visual indicators, in accordance with one or more techniques in this disclosure.

### DETAILED DESCRIPTION

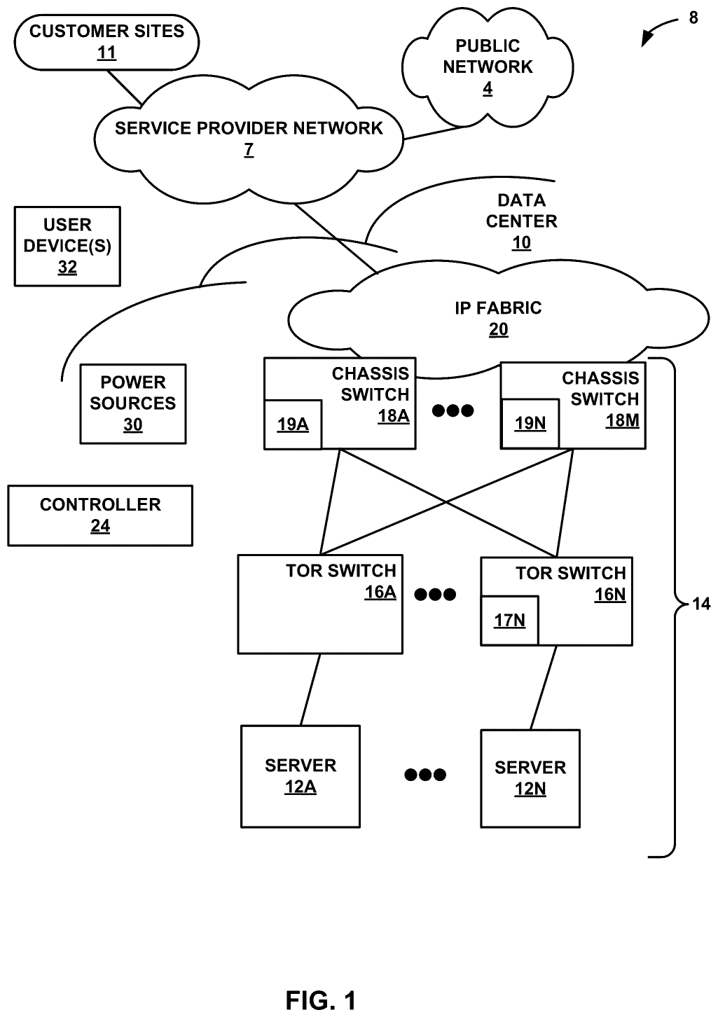

FIG. 1 is a block diagram illustrating an example network system 8 having computing infrastructure, in accordance with one or more techniques of this disclosure. In general, data center 10 provides an operating environment for applications and services for one or more customer sites 11 having one or more customer networks coupled to the data center by service provider network 7. Data center 10 may, for example, host infrastructure equipment, such as networking and storage systems, redundant power supplies, and environmental controls. Service provider network 7 is coupled to public network 4, which may represent one or more networks administered by other providers, and may thus form part of a large-scale public network infrastructure, e.g., the Internet. Public network 4 may represent, for instance, a local area network (LAN), a wide area network (WAN), the Internet, a virtual LAN (VLAN), an enterprise LAN, a layer 3 virtual private network (VPN), an Internet Protocol (IP) intranet operated by the service provider that operates service provider network 7, an enterprise IP network, or some combination thereof.

Although customer sites 11 and public network 4 are illustrated and described primarily as edge networks of service provider network 7, in some examples, one or more of customer sites 11 and public network 4 may be tenant networks within data center 10 or another data center. For example, data center 10 may host multiple tenants (customers) each associated with one or more virtual private networks (VPNs), each of which may implement one of customer sites 11.

Service provider network 7 offers packet-based connectivity to attached customer sites 11, data center 10, and public network 4. Service provider network 7 may represent a network that is owned and operated by a service provider to interconnect a plurality of networks. Service provider network 7 may implement Multi-Protocol Label Switching (MPLS) forwarding and in such instances may be referred to as an MPLS network or MPLS backbone. In some instances, service provider network 7 represents a plurality of interconnected autonomous systems, such as the Internet, that offers services from one or more service providers.

In some examples, data center 10 may represent one of many geographically distributed network data centers. As illustrated in the example of FIG. 1, data center 10 may be a facility that provides network services for customers. A customer of the service provider may be a collective entity such as enterprises and governments or individuals. For example, a network data center may host web services for several enterprises and end users. Other exemplary services may include data storage, virtual private networks, traffic engineering, file service, data mining, scientific- or super-computing, and so on. Although illustrated as a separate edge network of service provider network 7, elements of data center 10 such as one or more physical network functions (PNFs) or virtualized network functions (VNFs) may be included within the service provider network 7 core.

In this example, data center 10 includes storage and/or compute servers interconnected via a switch fabric provided by one or more tiers of physical network switches and routers, with servers 12A-12N (herein, “servers 12”) depicted as coupled to top-of-rack (TOR) switches 16A-16N. Servers 12 may also be referred to herein as “hosts” or “host devices.” Data center 10 may include many additional servers coupled to other TOR switches 16 of the data center 10.

Network devices 14 in the illustrated example include interconnected top-of-rack (or other “leaf”) switches 16A-16N (collectively, “TOR switches 16”) coupled to a distribution layer of chassis (or “spine” or “core”) switches 18A-18M (collectively, “chassis switches 18”). In addition, network device 14 may include servers 12. Although not shown, network devices 14 may also include, for example, one or more non-edge switches, routers, hubs, gateways, security devices such as firewalls, intrusion detection, and/or intrusion prevention devices, servers, computer terminals, laptops, printers, databases, wireless mobile devices such as cellular phones or personal digital assistants, wireless access points, bridges, cable modems, application accelerators, or other network devices.

In this example, TOR switches 16 and chassis switches 18 provide servers 12 with redundant (multi-homed) connectivity to IP fabric 20 and service provider network 7. Chassis switches 18 aggregate traffic flows and provides connectivity between TOR switches 16. TOR switches 16 may be network devices that provide layer 2 (MAC) and/or layer 3 (e.g., IP) routing and/or switching functionality. TOR switches 16 and chassis switches 18 may each include one or more processors and a memory and can execute one or more software processes. Chassis switches 18 are coupled to IP fabric 20, which may perform layer 3 routing to route network traffic between data center 10 and customer sites 11 by service provider network 7. The switching architecture of data center 10 is merely an example. Other switching architectures may have more or fewer switching layers, for instance.

Each of servers 12 may be a compute node, an application server, a storage server, or other type of server. For example, each of servers 12 may represent a computing device, such as an x86 processor-based server, configured to operate according to techniques described herein. Servers 12 may provide Network Function Virtualization Infrastructure (NFVI) for an NFV architecture.

Servers 12 host endpoints for one or more virtual networks that operate over the physical network represented here by IP fabric 20 and the switch fabric provided by network devices 14. Although described primarily with respect to a data center-based switching network, other physical networks, such as service provider network 7, may underlay the one or more virtual networks.

Network system 8 may include one or more user devices 32. User devices 32 may include one or more types of computing devices, such as laptops, desktops, thin clients, terminals, tablet computers, mobile computing devices (e.g., smartphones), augmented reality (AR) glasses/goggles, virtual reality (VR) glasses/goggles, and/or other types of computing devices. User devices 32 may include one or more devices used by an administrator of data center 10 to manage and/or monitor the status of one or more devices of data center 10. For example, a user device of user devices may be a smartphone that executes a companion application for one or more management devices of data center 10, such as controller 24.

In the example of FIG. 1, data center 10 may obtain energy from one or more power sources 30 for data center 10. Power sources 30 may include renewable energy sources, non-renewable energy sources, or a combination of renewable and non-renewable energy sources. For example, power sources 30 may include a connection to an electrical grid that provides power to network devices, such as servers 12, TOR switches 16, and controller 24.

Data center 10 includes a controller 24 that manages one or more devices of data center 10. For example, controller 24 may manage the configuration of TOR switches 16 based on instruction from an administrator and network data obtained from TOR switches 16. Controller 24 may obtain information from one or more network devices as part of managing data center 10. For example, controller 24 may poll network devices (e.g., TOR switches 16, chassis switches 18, etc.) for the status of the network devices.

One or more components and devices of data center 10 may include visual indicators to visually indicate information, such as a status, of the component or device. For example, TOR switches 16 and chassis switches 18 may include one or more types of visual indicators such as visual indicators 17, 19. Visual indicators 17, 19 may include LED lights, incandescent lights, and/or other types of visual indicators. For instance, TOR switch 16N may include a plurality of LED lights that indicate connection status of physical ports of TOR switch 16N. In some examples, one or more of network devices 14, such as TOR switch 16A, may not include any physical visual indicators. In some examples, TOR switches 16 and/or chassis switches 18 do not include visual indicators, such as TOR switch 16A. While the example in FIG. 1 illustrates certain network devices including visual indicators and certain network devices not including visual indicators, the examples described in this disclosure is just one example and the network devices may either include or not include visual indicators.

Visual indicators 17, 19 may consume power. While each individual visual indicator may consume an insignificant amount of power, the total power consumption of all visual indicators of devices in data center 10 may consume a significant amount of power when network devices 14 are equipped with physical visual indicators. For example, a single LED may consume 3.3 Volts (V)×10 milliamperes (mA)=33 milliwatts (mW) of power. An example server rack (e.g., a server of servers 12) may include 40 sub-racks each including 100 LEDs. This means that a sub-rack may draw 100×33 mW=3.3 Watts (W) of power, and a rack may draw 40×3.3 W=132 W when every LED visual indicator is activated. When only 10% of the LEDs are activated, the rack may draw 13.2 W of power. In a data center housing 800 racks, this means that LED visual indicators may draw 10,500 W of power when only 10% of the LEDs are activated.

Customers and/or providers of data center 10 may find it beneficial to control the energy consumed by physical visual indicators and to reduce reliance upon the physical visual indicators. For instance, the power consumption of the visual indicators may significantly increase the cost of operating data center 10. In addition, an administrator may find it beneficial to be able to view visual indicators from a location other than of a physical proximity of the network devices. Further, the inclusion of physical visual indicators in network devices may increase the cost of the network devices (e.g., due to the added complexity and components of the physical visual indicators, increasing potential downtime due to repairs of the visual indicators) and reduce the performance and functionality of the network devices (e.g., by limiting the amount of space for cooling intakes and additional ports).

In accordance with the techniques described herein, controller 24 may obtain visual indicator status information from one or more network devices 14 of data center 10 and generate, based on the visual indicator status information of the network devices 14, a graphical user interface (GUI) that includes visual representations of the network devices 14 and one or more virtual visual indicators overlaid on the visual representations of the network devices 14 that each indicate a state of the network devices 14 and/or a state of one or more links associated with the network devices 14 (collectively referred to herein as “state information”).

For example, network devices 14 may each obtain state information of the network device and/or links associated with the network device. As one example, TOR switch 16A may obtain information indicative of a state of TOR switch 16A and/or a state of one or more links associated with TOR switch 16A, such as the status of links between TOR switch 16A and other network devices of network devices 14 (e.g., chassis switch 18A, chassis switch 18M, server 12A, etc.). State information may include information indicative of a state of a network device, such as an alarm status (e.g., no alarm, minor alarm, major alarm, etc.), device status (e.g., off, booting, operating normally, etc.), master status (e.g., network device is configured as a primary or that a routing engine is operational, network device is not configured as a primary or that a routing engine is not operational, etc.), selected port parameter (e.g., administrative, speed, duplex, Power over Ethernet (POE), etc.), chassis status (e.g., powered on, voltage or temperature error, software error, successful operating system installation, fan trays operating normally, fan tray error, etc.), or other information associated with the state of the network device. State information may additionally, or alternatively, include information indicative of a state of one or more ports of the network device such as a state of a management port (e.g., port inactive, port with a 1 Gbps link, port with a 10/100 Mbps link, no activity on the link, activity on the link, etc.) and a state of an interface port (e.g., no link, link fault, link failure, link established, link established with link activity, no transceiver installed, transceiver installed, transceiver not supported, etc.), or other state information associated with a port of the network device. In some examples, state information may include information indicative of a state of one or more components of the network device such as a state of a fan (e.g., fan status), a state of a power supplied (e.g., power supply failure, power supply operating normally, power supply off, etc.), and/or a state of other components.

Based on the state information of network device 14, network devices 14 may generate visual indicator status information for virtual or simulated visual indicators of the network device to virtually indicate the state information of the network device. Visual indicator status information may include, for example, a particular color or other characteristic corresponding to a particular state of the network device and/or particular state of a link to be displayed by a virtual visual indicator. In some examples, network devices 14 may generate the visual indicator status information for virtual visual indicators even when network devices 14 do not include any physical visual indicators. Virtual visual indicators of network devices 14 may virtually indicate the state information of network devices 14 via a graphical user interface as if network devices 14 were equipped with physical visual indicators that indicate the state information of network devices 14.

In an example, TOR switch 16A does not include any physical visual indicators associated with a plurality of ports of TOR switch 16A. In this example, TOR switch 16A may detect a network event such as determining that a link associated with a particular port has failed. TOR switch 16A may generate visual indicator status information for a virtual visual indicator to indicate the status of the link associated with the particular port of TOR switch 16A even though the particular port of TOR switch 16A does not include a physical visual indicator. For example, the visual indicator status information may include information associating (e.g., mapping) a virtual visual indicator associated with the particular port of TOR switch 16A with a particular color (or other characteristic) indicative of the failed status of the link associated with the particular port of TOR switch 16A.

Network devices 14 may each maintain visual indicator status information of a corresponding network device. A network device 14, such as TOR switch 16A may store visual indicator status information in memory of TOR switch 16A, such as in a table within a routing unit of TOR switch 16A.

Although the example described above describes a network device that does not include physical visual indicators generating visual indicator status information, network devices 14 may generate visual indicator status information irrespective of whether network devices are equipped with physical visual indicators. In an example, TOR switch 16N is equipped with one or more physical visual indicators. In this example, TOR switch 16N may also generate visual indicator status information indicative of the state of TOR switch 16N and/or links associated with TOR switch 16N.

Controller 24 may obtain the visual indicator status information of one or more network devices 14. In some examples, network devices 14 may export the configurations of visual indicators on a periodic basis and/or in response to a request from controller 24. For example, controller 24 may obtain the visual indicator status information from network devices 14 in response to a poll from controller 24. Controller 24 may receive the visual indicator status information in one or more ways, such as a transmission of information from a table of the visual indicator status information of a network device or receiving an indication of one or more changes to the visual indicator status information from the network device, among other ways of exporting the visual indicator status information.

Controller 24 may generate, based on the visual indicator status information of one or more network devices 14, a graphical user interface (GUI) including visual representations of one or more network devices 14 and one or more virtual visual indicators associated with the one or more network devices 14 overlaid on the virtual representations of the one or more network devices 14 that indicate the state information of the one or more network devices 14. Controller 24 may generate a visual representation for one or more network devices 14 that each replicate the physical appearance of the one or more network devices 14. For example, controller 24 may obtain device information about each network device of network devices 14, such as a model number of the network device, a revision number of the network device, a manufacturer of the network device, and/or other information regarding the network device. Controller 24 may obtain the device information during a configuration of the network device and/or network. For example, controller 24 may obtain device information regarding TOR switch 16A when a network administrator initially configures TOR switch 16A. In another example, controller 24 may obtain device information regarding TOR switch 16A by polling chassis switch 18A for information. In some examples, controller 24 may obtain or otherwise receive images that are visual representations of network devices. For example, controller 24 may receive an image of the front and back of TOR switch 16A during an initialization process of TOR switch 16A and/or the network. Controller 24 may obtain the images from one or more sources, such as a manufacturer's database, from an administrator device, and/or from network devices 14 among other sources. Controller 24 may generate, based on the device information of TOR switch 16A, a visual representation of TOR switch 16A that replicates the front side of TOR switch 16A (e.g., the front panel of TOR switch 16A including, for example, network ports, management ports, system LEDs, etc.) and the back side of TOR switch 16A (e.g., back or rear panel of chassis switch 18A including, for example, electrical power connections, management ports, console ports, etc.). In this example, controller 24 may generate a visual representation of TOR switch 16A that includes virtual visual indicators visually overlaying ports of TOR switch 16A to which the virtual visual indicators correspond. In some examples, controller 24 may generate a visual representation of a rack within data center 10, where the rack includes several network devices.

Controller 24 may output, for display on a display device, the GUI including visual representations of one or more network devices 14 and virtual visual indicators associated with the one or more network devices 14. Controller 24 may provide the GUI to one or more recipient devices, such as one or more user devices 32, in response to a request for information regarding network devices 14. Controller 24 may provide the GUI via a web-based application accessible by user devices 32. For example, controller 24 may output the GUI for display on a display device of a user device 32 via an application executed by the user device 32. In some examples, controller 24 may output the GUI via one or more devices connected to controller 24, such as thin client, that is connected to controller 24.

In some examples, user devices 32 may obtain visual indicator status information from network devices 14. For example, a user or administrator may use a command line interface to interact with TOR switch 16A to obtain visual indicator status information of TOR switch 16.

The techniques of this disclosure may provide one or more improvements to the computer-related field of computer networking that are integrated within a practical application. By utilizing virtual visual indicators instead of physical visual indicators, network devices 14 may be designed and manufactured without including any physical visual indicators, or physical visual indicators of network devices 14 may be deactivated, which reduces power consumption by the network device. The removal of visual indicators from design requirements may also enable the network device to be constructed with improved space for the intake of air into the network device for improved cooling and/or allow for the inclusion of more network ports (e.g., using the space previously reserved for physical visual indicators for network ports instead). In another example, the use of virtual visual indicators may enable a network administrator to view the status of a network device without needing to physically view the device. For instance, a network administrator may be able to view the status of a network device from an entirely different location from the network device to provide remote monitoring and/or troubleshooting of the network device.

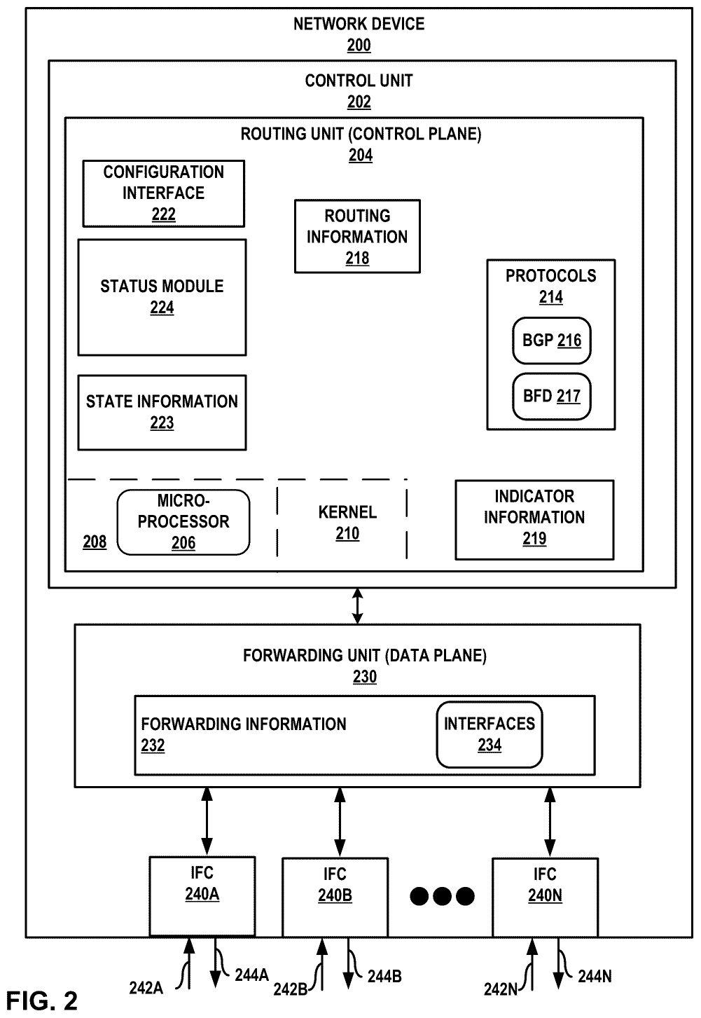

FIG. 2 is a block diagram illustrating an example of a network device according to the techniques described herein. Network device 200 may representation an example implementation of network devices 14 as illustrated in FIG. 1. For example, while described in the context of TOR switch 16A, network device 200 may be any of network devices 14.

As shown in FIG. 2, network device 200 includes a control unit 202 having a routing unit 204 (control plane), and is coupled to forwarding unit 230 (data plane). Forwarding unit 230 is associated with one or more interface cards 240A-240N (“IFCs 240”) that receive packets via inbound links 242A-242N (“inbound links 242”) and send packets via outbound links 244A-244N (“outbound links 244”). IFCs 240 are typically coupled to links 242, 244 via a number of interfaces (e.g., ports not shown). Inbound links 242 and outbound links 244 may represent physical interfaces, logical interfaces, or some combination thereof. Inbound links 242 and outbound links 244 may be collectively referred to as “links 242, 244”.

Elements of control unit 202 and forwarding unit 230 may be implemented solely in software, or hardware, or may be implemented as combinations of software, hardware, or firmware. For example, control unit 202 may include one or more processors 206 that may represent, one or more microprocessors, digital signal processors (“DSPs”), application specific integrated circuits (“ASICs”), field programmable gate arrays (“FPGAs”), or any other equivalent integrated or discrete logic circuitry, or any combination thereof, which execute software instructions. In that case, the various software modules of control unit 202 may comprise executable instructions stored, embodied, or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable storage media may include random access memory (“RAM”), read only memory (“ROM”), programmable read only memory (PROM), erasable programmable read only memory (“EPROM”), electronically erasable programmable read only memory (“EEPROM”), non-volatile random access memory (“NVRAM”), flash memory, a hard disk, a CD-ROM, a floppy disk, a cassette, a solid state drive, magnetic media, optical media, or other computer-readable media. Computer-readable media may be encoded with instructions corresponding to various aspects of Network device 200, e.g., protocols, processes, and modules. Control unit 202, in some examples, retrieves and executes the instructions from memory for these aspects.

Routing unit 204 operates as a control plane for network device 200 and includes an operating system that provides a multi-tasking operating environment for execution of a number of concurrent processes. Routing unit 204 includes a kernel 210, which provides a run-time operating environment for user-level processes. Kernel 210 may represent, for example, a UNIX operating system derivative such as Linux or Berkeley Software Distribution (“BSD”). Kernel 210 offers libraries and drivers by which user-level processes may interact with the underlying system. Hardware environment 208 of routing unit 204 includes processor 206 that executes program instructions loaded into a main memory (not shown in FIG. 2) from a storage device (also not shown in FIG. 2) in order to execute the software stack, including both kernel 210 and processes executing on the operating environment provided by kernel 210.

Kernel 210 provides an operating environment that executes various protocols 214 at different layers of a network stack, including protocols for implementing EVPN networks. For example, routing unit 204 includes network protocols that operate at a network layer of the network stack. Protocols 214 provide control plane functions for storing network topology in the form of routing tables or other structures, executing routing protocols to communicate with peer routing devices and maintain and update the routing tables, and provide management interface(s) to allow user access and configuration of network device 200. That is, routing unit 204 is responsible for the maintenance of routing information 218 to reflect the current topology of a network and other network entities to which network device 200 is connected. In particular, routing protocols 214 periodically update routing information 218 to reflect the current topology of the network and other entities based on routing protocol messages received by Network device 200.

In the example of FIG. 2, routing protocols 214 include the interior gateway protocol (IGP) 215 (e.g., Intermediate System to Intermediate System (IS-IS) or Open Shortest Path First (OSPF)), Border Gateway Protocol (“BGP”) 216, and/or other routing protocols for exchanging routing information with other routing devices and for updating routing information 218. In EVPN, network device 200 may use BGP to advertise to other network devices the MAC addresses network device 200 as learned from local customer edge network devices to which network device 200 is connected. In particular, network device 200 may use a BGP route advertisement message to announce reachability information for the EVPN, where the BGP route advertisement specifies one or more MAC addresses learned by network device 200 instead of L3 routing information. Network device 200 updates routing information 218 based on the BGP route advertisement message. Routing unit 204 may include other protocols not shown in FIG. 2, such as an MPLS label distribution protocol and/or other MPLS protocols. Routing protocols 214 include Bidirectional Forwarding Detection (“BFD”) protocol 217 for exchanging BFD messages to detect node failure and/or network link failure. In some examples, BFD protocol 217 may include seamless-BFD (S-BFD) or multihop-BFD (MH-BFD).

Routing information 218 may include information defining a topology of a network, including one or more routing tables and/or link-state databases. Typically, the routing information defines routes (i.e., series of next hops) through a network to destinations/prefixes within the network learned via a distance-vector routing protocol (e.g., BGP) or defines the network topology with interconnected network links (e.g., interfaces) learned using a link state routing protocol (e.g., IS-IS or OSPF). In contrast, forwarding information 232 is generated based on selection of certain routes within the network and maps packet key information (e.g., L2/L3 source and destination addresses and other select information from a packet header) to one or more specific next hops forwarding structures within forwarding information 232 and ultimately to one or more specific output interface ports of IFCs 240. Routing unit 204 may generate forwarding information 232 in the form of a radix tree having leaf nodes that represent destinations within the network, a series of tables, a link list, a database, a flat file, or various other data structures.

Routing unit 204 includes a configuration interface 222 that receives and may report configuration data for network device 200. Configuration interface 222 may represent a command line interface; a graphical user interface; Simple Network Management Protocol (“SNMP”), Netconf, or another configuration protocol; or some combination of the above in some examples. Configuration interface 222 receives configuration data configuring network device 200, and other constructs that at least partially define the operations for network device 200, including the techniques described herein. For example, an administrator may, after powering-up, activating or otherwise enabling network device 200 to operate within a network, interact with control unit 202 via configuration interface 222 to configure, e.g., interfaces of network device 200.

Forwarding unit 230 represents hardware and logic functions that provide high-speed forwarding of network traffic. Forwarding unit 230 typically includes a set of one or more forwarding chips programmed with forwarding information that maps network destinations with specific next hops and the corresponding output interface ports. In general, when Network device 200 receives a packet via one of inbound links 242, forwarding unit 230 identifies an associated next hop for the data packet by traversing the programmed forwarding information based on information within the packet, e.g., in the case of BUM packet forwarding, the transport label and/or inclusive multicast label. Forwarding unit 230 forwards the packet on one of outbound links 244 mapped to the corresponding next hop.

In the example of FIG. 2, forwarding unit 230 includes forwarding information 232. In accordance with routing information 232, forwarding unit 230 stores forwarding information 232 that maps packet field values to network destinations with specific next hops and corresponding outbound interface ports. For example, routing unit 204 analyzes routing information 218 and generates forwarding information 232 in accordance with routing information 218. Forwarding information 232 may be maintained in the form of one or more tables, link lists, radix trees, databases, flat files, or any other data structures.

Network device 200 may store information regarding the state of network device in state information 223. State information 223 may store information that includes the state of one or more components of network device 200 (e.g., state of a power supply, state of a fan, state of a network card), state of interfaces of network device 200 (e.g., operational, disabled, minor alarm, major alarm, etc.), state of network device itself (e.g., powered on, error, operating normally, etc.). State information 221 may store information in one or more forms, such as tables, indexes, and/or other types of formats.

Routing unit 204 includes status module 224. Status module 224 may be a plugin, module, process, engine, executable, or other type of software component of routing unit 204. Status module 224 may obtain state information from one or more components of network device 200. Status module 224 may obtain state information from components that include power supplies of network device 200, fan controllers of network device 200, IFC 240s, interfaces 234, and/or other components of network device 200. In an example, status module 224 obtains state information from IFC 240B regarding the status of interfaces of IFC 240B that includes a first interface being in disabled state and a second interface being in a major alarm state. Status module 224 may additionally, or alternatively, obtain state information regarding links 242, 244. Status module 224 may obtain state information regarding one or more of links 242, 244 that includes whether the links are in an alarm state, whether there is no link, whether there is activity on the links, and/or other information. In an example, status module 224 obtains state information from IFC 240B that includes information regarding inbound link 242B and outbound link 244B. Status module 224 may store state information in state information 223.

Status module 224 may generate visual indicator status information for virtual visual indicators. Status module 224 may generate the visual indicator status information based on the state information corresponding to the state of the components of network device 200. For example, status module 224 may generate visual indication status information that includes configurations of virtual visual indicators that are representative of the state of network device 200 (e.g., the state of components, interfaces, and/or links of network device 200). Status module 224 may generate the visual indicator status information by mapping the state of a component/link of network device 200 to a characteristic (e.g., color, animation, etc.) of a visual indicator corresponding to the component/link of network device 200.

Status module 224 may generate visual indicator status information even when network device 200 is not equipped with physical visual indicators. For example, status module 224 may generate visual indicator status information for virtual visual indicators that are representative of visual indicators not physically present in network device 200.

Status module 224 may store the visual indicator status information in indicator information 219. Indicator information 219 may be a data store, repository, or other type of data storage. Indicator information 219 may store one or more tables with entries for virtual visual indicators and statues of the virtual visual indicators. In an example, status module 224 generates visual indicator status information that includes a virtual visual indicator associated with an interface of IFC 240B configured as a first color to indicate a state of the first interface of IFC 240B, a second virtual visual indicator associated with a second interface of IFC 240B that is inactive and configured as a second color to indicate a state of the second interface of IFC, and/or any other visual indicators associated with components of network device 200 to indicate a state of the components. Status module 224 updates a table of virtual visual indicators stored in indicator information 219 with the visual indicator status information of the two interfaces of IFC 240B.

Status module 224 may provide the visual indicator status information to a controller, such as controller 24 as illustrated in FIG. 1, or other recipient devices. Status module 224 may provide the status information to controller 24 in response to a request from controller 24 and/or as part of periodically reporting the visual indicator status information. For example, controller 24 obtains visual indicator status information according to a periodic timeframe (e.g., seconds, minutes, hours, etc.). Status module 224 may provide a portion or the entirety of the visual indicator status information of indicator information 219 to controller 24. For example, status module 224 may provide only the portion of visual indicator status information that includes changes to the visual indicator status information since status module 224 last provided visual indicator status information to controller 24.

In some examples, status module 224 may output for display on a display device visual indicator status information. Status module 224 may receive a request for visual indicator status information from a device connected to network device 200 (e.g., plugged in via a network cable, connected via a web portal, etc.) and may output visual indicator status information in the form of a GUI or in text form for display via a command-line interface of the device.

In some examples, network device 200 may provide the visual indicator status information to a controller (e.g., controller 24 of FIG. 1) to generate a GUI including a visual representation of network devices 200 and one or more virtual visual indicators overlaid on the visual representations of network device 200 that each indicate a state of a corresponding component of network device 200 and/or a state of one or more links associated with network devices 200.

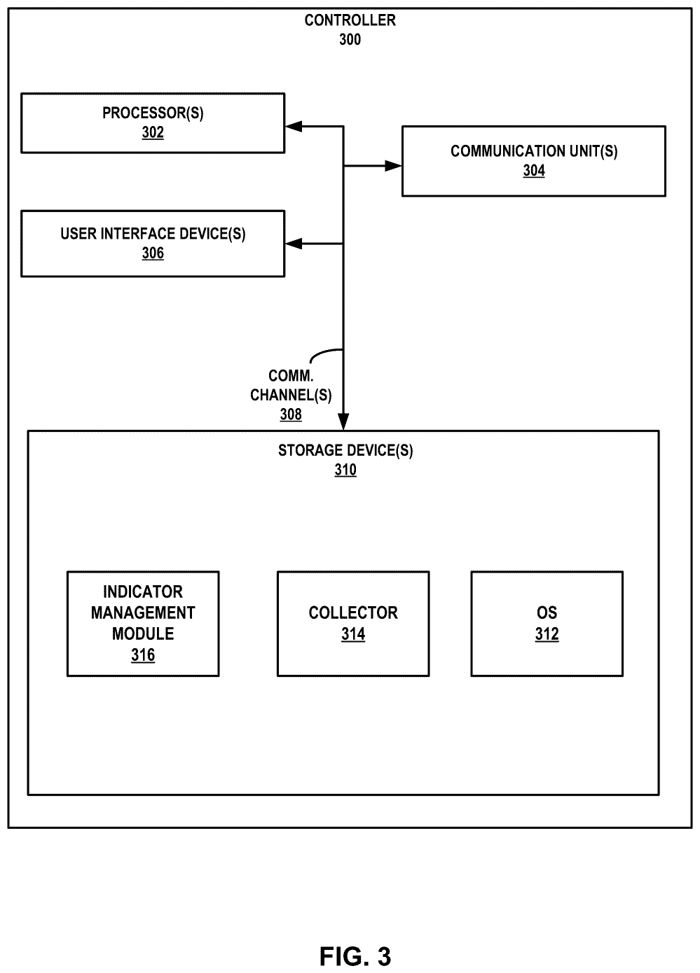

FIG. 3 is a block diagram of a controller 300, in accordance with one or more techniques of this disclosure. While described in the context of controller 24 as illustrated in FIG. 1, controller 300 may be representative of one or more other devices of FIG. 1.

Controller 300 includes one or more of processors 302. Processors 302 may include multi-core processors, processing circuitry, chiplets, field-programmable gate arrays (FPGAs), compute nodes, virtualized processors, and other types of processors. Processors 302 may execute the instructions of one or more software components of controller 24.

Controller 300 includes one or more of communication units 304. Communication units 304 may include one or more types of communications units, such as transceivers, optical network interfaces, network interface cards (NICs), modems, radios, and other types of communication units. Communication units 304 may enable controller 300 to communicate with other devices and systems, such as network devices 14 as illustrated in FIG. 1.

Controller 300 includes one or more of user interface devices 306. User interface devices 306 may include one or more devices capable of receiving input, such as keyboards, mice, touchscreens, microphones, cameras, and other types of input devices. User interface devices 306 may include one or more devices capable of generating output, such as displays, speakers, haptic engines, and other types of output devices.

Controller 300 includes one or more of communication channels 308 (illustrated as “COMM. CHANNEL(S) 308” in FIG. 3). Communication channels 308 may include one or more types of communication channels, such as hardware interconnects, software interconnects, internal device communication channels, and/or other types of communication channels. For example, communication channels 308 may include hardware interconnects between processors 302 and storage devices 310.

Controller 300 includes storage devices 310. Storage devices 310 may include one or more types of storage devices, such as magnetic tapes, hard drives, solid state drives, NVM Express drives, read-only memory (ROM), electrically erasable programmable read-only memory (EEPROM), and/or other types of volatile and/or non-volatile storage devices. Storage devices 310 may include non-volatile and/or volatile memory. For example, storage devices 310 may include non-volatile storage that stores instructions of software components of controller 300.

Operating system 312 (illustrated as “OS 312”, hereinafter “OS 312”) may be an operating system of controller 300 that provides an execution environment for one or more software components of controller 300. For example, OS 312 may provide an execution environment for collector 314.

Collector 314 may be a plugin, module, process, engine, executable, or other type of software component of controller 300. Collector 314 may obtain information from one or more of network devices 14. Collector 314 may obtain information that includes make and model of network devices 14, configuration information of network devices 14, and/or visual indicator status information of network devices 14. Collector 314 may configure a network device to provide the visual indicator status information to collector 314 on a periodic basis (e.g., seconds, minutes, hours, etc.).

Indicator management module 316 may be a plugin, module, process, engine, executable, or other type of software component of controller 300. Indicator management module 316 may process visual indicator status information obtained by collector 314. Indicator management module 316 may process visual indicator status information to generate GUIs that include a visual representation of a network device and virtual visual indicators indicating the state of the network device or the state of one or more links associated with the network device. Indicator management module 316 generates a GUI that includes virtual visual indicators whose appearance is based on the visual indicator status information of the network device. Indicator management module 316 may generate the GUI as including virtual visual indicators, where the appearance of the virtual visual indicators simulate the appearance of physical visual indicators that may or may not be present on the network device.

Indicator management module 316 may generate GUIs that include UI elements that are representative of the network device. Indicator management module 316 obtain images of the network device from one or more sources, such as from online repositories (e.g., from manufacturers of network devices 14), from the network device itself, and/or other sources. Indicator management module 316 may obtain images of different perspectives of the network device including, for example, one or more sides of the network device. For example, indicator management module 316 may obtain images of front and/or back of TOR switch 16A (e.g., from the perspective of looking at a rack into which TOR switch 16A is mounted).

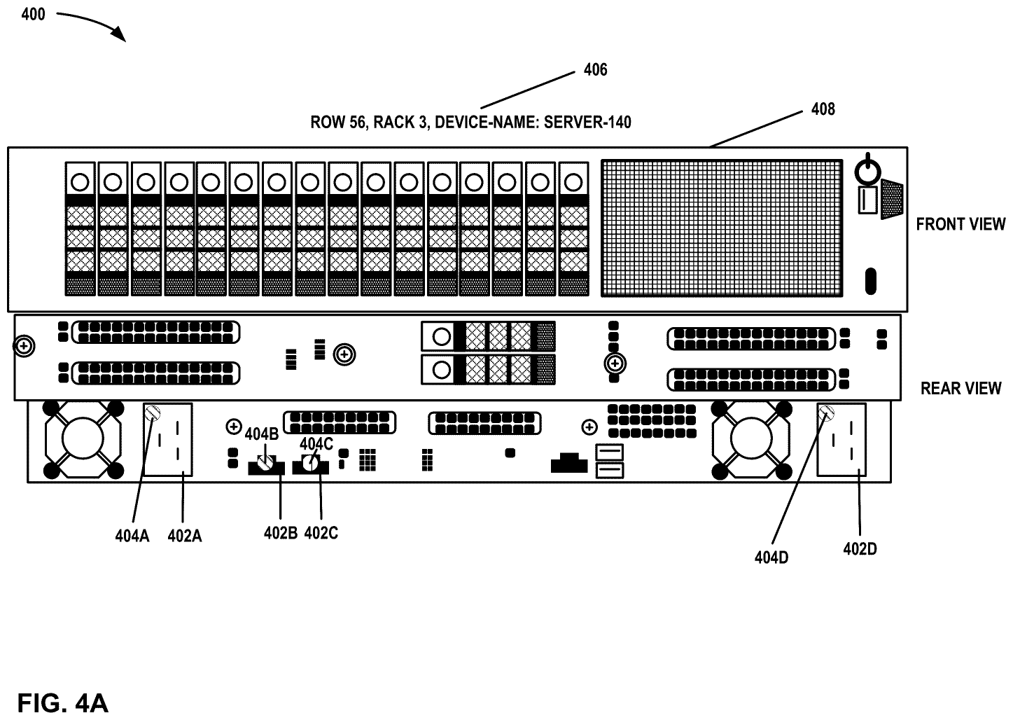

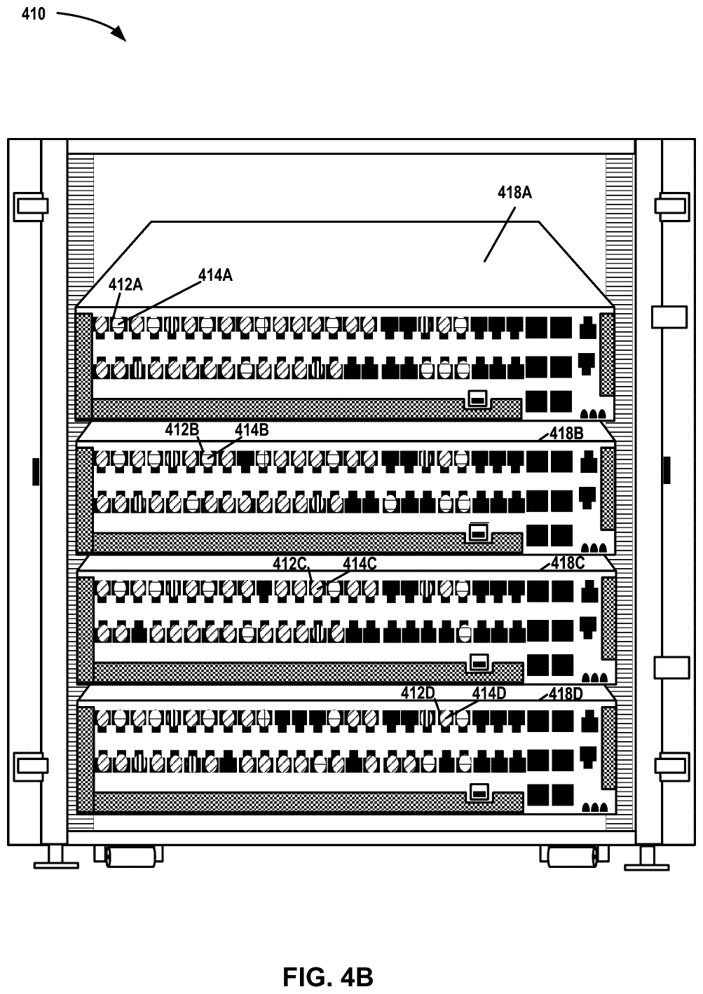

Indicator management module 316 may generate GUIs that include one or more virtual visual indicators overlayed with the images of the network device, as further illustrated and described in FIG. 4A. The virtual visual indicators may indicate the state of the network device, such as whether the network device is powered on, whether the network device is experiencing errors, configuration states of the network device (e.g., whether an OS is loaded, whether the network device is in a particular mode, etc.), and/or other states. In an example, indicator management module 316 obtains visual indicator status information from TOR switch 16A that includes information regarding a first visual indicator associated with a power supply of TOR switch 16A and a second visual indicator associated with an interface of TOR switch 16A. Indicator management module 316 generates a GUI that includes a visual representation of TOR switch 16A (e.g., one or more representative images of a switch that is the same make/model of TOR switch 16A) and the first visual indicator overlayed on the image of TOR switch 16A at a location consistent with a visual representation of the power supply of TOR switch 16A and the second visual indicator overlayed on the image of TOR switch 16A at a location consistent with a visual representation of the interface of TOR switch 16A.

In some examples, indicator management module 316 may generate GUIs that include visual representations of multiple network devices, as further illustrated and described in FIG. 4B. Indicator management module 316 may generate GUIs that include a visual representation of the multiple network devices as they would appear in a data center, such as a rack of network devices 14 in data center 10. Indicator management 316 may use information regarding the configuration of the network devices to determine the position of the network devices within the rack. In an example, indicator management module 316 obtains information regarding the configuration information of network devices 14 and/or a network topology of network devices 14 of data center 10 that may indicate the physical placement of network devices 14 within data center 10. Based on the configuration information of network devices and/or the topology of network devices 14, Indicator management module 316 generates a GUI that includes a visual representation of a rack of data center 10 that includes visual representations of multiple network devices within that the same rack, such as a visual representation of a rack including TOR switch 16A and one or more servers 12 connected to TOR switch 16A.

Indicator management module 316 may cause one or more components of controller 300 to output a GUI for display on one or more computing devices or display devices, such as administrator devices, thin clients, displays of user interface devices 306, and/or other types of devices. In an example, indicator management module 316 provides data regarding the GUI to communication units 304 via communication channels 308 to output the data regarding the GUI to an administrator device via a network interface of communication units 304.

FIG. 4A is a conceptual diagram of a graphical user interface 400 (hereinafter “GUI 400”) that includes a representation of a server, in accordance with one or more techniques of this disclosure. For the purposes of clarity, FIG. 4A is described in the context of FIG. 1. For example, FIG. 4A may be a representation of a network device, such as server 12A or any other network device.

A controller, such as controller 24, may generate GUI 400. Controller 24 may generate GUI 400 using visual indicator status information obtained from server 12A. In an example, controller 24 polls server 12A. Server 12A provides visual indicator status information to controller 24 in response to the poll.

Controller 24 may generate GUI 400 as including identifier 406. Identifier 406 may include one or more identifiers of server 12A, such as the name of server 12A (“DEVICE-NAME: SERVER-140”), a location of server 12A within data center 10 (“ROW 56, RACK 3”), and/or other information.

Controller 24 may generate GUI 400 as including a visual representation of server 12A, e.g., device representation 408. Device representation 408 may be based on the physical appearance of server 12A. In the example of FIG. 4A, device representation 408 includes a visual representation of a front view of server 12A (e.g., the side of server 12A facing “outwards” from a network rack) and a visual representation of a rear view of server 12A (e.g., the side of server 12 facing the opposite direction from the front of server 12A). Controller 24 may generate device representation 408 using information from one or more sources, such as a manufacturer of the network device, the network device itself, and/or other sources of information.

Controller 24 may generate GUI 400 as including visual representations of interfaces, e.g., interface representations 402A-402C (collectively, “interface representations 402”). Interface representations 402 may include one or more visual representations of physical interfaces of server 12A, such as Ethernet ports, USB ports, SD card ports, optical ports, and/or other types of ports/interfaces of server 12A.

Controller 24 may generate GUI 400 as including virtual visual indicators 404A-404D (collectively, “virtual visual indicators 404”). Virtual visual indicators 404 may indicate the status of one or more components of server 12A. For example, virtual visual indicator 404A may indicate a status of a physical port of server 12A represented by interface representation 402A, virtual visual indicator 404B may indicate a status of a physical port of server 12A represented by interface representation 402B, and so on. Virtual visual indicators 404 may be representative of physical visual indicators of server 12A and/or simulate visual indicators not physically present on server 12A. In an example, controller 24 generates virtual visual indicators 402 for server 12A irrespective of whether server 12A includes physical visual indicators.

Controller 24 may generate virtual visual indicators 404 based on visual indicator status information obtained from server 12A. In an example, controller 24 obtains visual indicator status information that includes visual status information for ports 402 and generates virtual visual indicators 404 within GUI 400 based on the visual indicator status information obtained from server 12A.

Controller 24 may generate GUI 400 with virtual visual indicators 404 visually overlayed on device representation 408. Controller 24 may generate GUI 400 with virtual visual indicators 404 visually overlaying device representation 408 at visual locations consistent with the location of components of server 12A, such as overlayed over interface representations 402. In the example of FIG. 4A, controller 24 generates GUI 400 with virtual visual indicator 404A visually overlaying a power port of server 12A represented by interface representation 402A, virtual visual indicator 404B visually overlaying an Ethernet port of server 12A represented by interface representation 402B, and so on.

Controller 24 may output GUI 400 for display via display devices. Controller 24 may generate an instance of GUI 400 and output the instance of GUI 400 for display via a display device, such as an administrator computer, a smartphone, a tablet computer, and/or other type of device. Controller 24 may generate additional instances of GUI 400 that include changes to the status of virtual visual indicators 404 (e.g., indicative of a change in state information of the network device). In an example, controller 24 receives second visual indicator status information (e.g., visual indicator status information received at a second time) of virtual visual indicators 402 indicative of a state of server 12A at the second time. Controller 24 generates a second instance of GUI 400 that includes changes to virtual visual indicators 402 that are based on the second visual indicator status information. Controller 24 may generate updated instances of GUI 400 that include changes to virtual visual indicators 404, such as changes in the color of virtual visual indicators 404, changes in the animation of virtual visual indicators 402 (e.g., blinking, solid, pulsing multiple colors, etc.), and/or other changes to the visual appearance of virtual visual indicators 402. Controller 24 then outputs the updated instance of GUI 400 for display on a display device.

FIG. 4B is a conceptual diagram of a graphical user interface that includes a representation of a rack of network devices, in accordance with one or more techniques of this disclosure. For the purposes of clarity, FIG. 4B is described in the context of FIG. 1. For instance, FIG. 4B may be a representation of network devices 14 that include TOR switch 16A or any other network device.

A controller, such as controller 24, may generate GUI 410 as a visual representation of network devices in a rack within a data center, such as data center 10 of FIG. 1. Controller 24 may generate GUI 410 in response to a request from an administrator device. In an example, controller 24 receives a request from application executed by a user device of an administrator to generate GUI 410 and, in response, controller 24 generates GUI 410 and outputs GUI 410 for display on the user device.

Controller 24 may generate GUI 410 as including a visual representation of multiple network devices, e.g., device representations 418A-418D (collectively, “device representations 418”). Device representations 418 may be a visual representations of network devices in a rack. Controller 24 may generate device representations 418 as including a visual representation of each of the network devices in their relative locations within the rack. In this example, controller 24 generates GUI 410 as including device representation 418A that provides a visual representation of TOR switch 16A visually located at the top of the rack and device representations 418B-418D that provide visual representations of other network devices, such as servers, located in other slots of the rack.

Controller 24 may generate GUI 410 as including visual representations of interfaces of corresponding network devices, e.g., interface representations 414A-414D (collectively, “interface representations 414”). For example, interface representation 414A may include a visual representation of a physical interface of TOR switch 16A of the rack, interface representation 414B may include a visual representation of a physical interface of a server of the rack, interface representation 414C may include a visual representation of a physical interface of another server of the rack, and so on.

Controller 24 may generate GUI 410 as including virtual visual indicators 412A-412D (collectively, “virtual visual indicators 414”). Virtual visual indicators 412 may each indicate the status of a corresponding component of a corresponding network device. For example, virtual visual indicator 414A may indicate a status of a physical port of TOR switch 16A of the rack, virtual visual indicator 414B may indicate a status of a physical port of a server of the rack, virtual visual indicator 414C may indicate a status of a physical port of another server of the rack, and so on.

Controller 24 may generate virtual visual indicators 414 based on visual indicator status information obtained from the network devices of the rack. In an example, controller 24 obtains visual indicator status information that includes visual status information for ports of network devices in the rack, and generates virtual visual indicators 404 corresponding to the ports of the network devices in the rack within GUI 400 based on the visual indicator status information.

Controller 24 may output GUI 410 to one or more display devices. Controller 24 may generate updated instances of GUI 410 that include one or more changes, such as changes to configuration of virtual visual indicators 402B and/or changes to the configuration of the network devices of the rack. For example, controller 24 may generate an updated instance of GUI 410 in response to receiving an indication that the configuration of a particular visual indicator has changed.

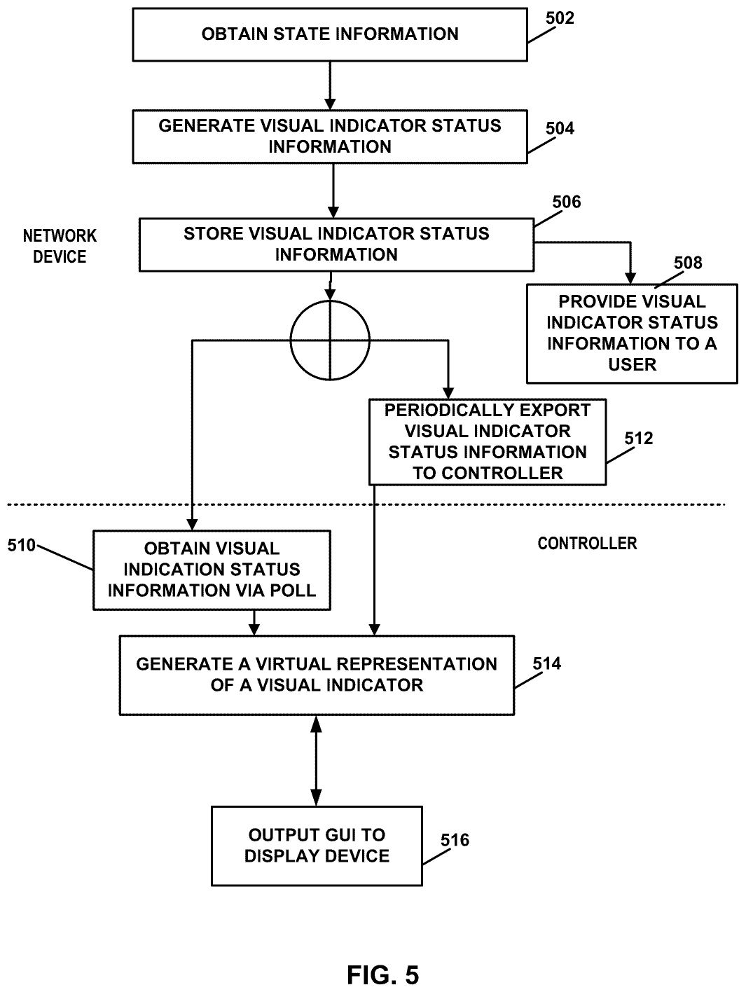

FIG. 5 is a flow diagram illustrating an example operation for providing a graphical user interface including virtual visual indicators, in accordance with one or more techniques in this disclosure. For the purposes of clarity, FIG. 5 is described in the context of FIG. 1.

A network device, such as TOR switch 16A, obtains state information of TOR switch 16A (502). TOR switch 16A may obtain state information indicating the state of components of TOR switch 16A that include fans, power supplies, interfaces, network cards, and/or other components of TOR switch 16A, and/or the state of links of TOR switch 16A. In addition, TOR switch 16A may obtain the state information that is indicative of an overall state of TOR switch 16A itself (e.g., powered on, OS loaded, thermal error, etc.).

TOR switch 16A generates visual indicator status information based on the state information (504). TOR switch 16A may generate visual indicator status information for a component of TOR switch 16A by mapping the state of the corresponding component of TOR switch 16A to a color/animation or other characteristic of the visual indicator associated with the corresponding component. TOR switch 16A may generate visual indicator status information irrespective of whether TOR switch 16A is equipped with physical visual indicators.

TOR switch 16A stores visual indicator status information (506). TOR switch 16A may store the visual indicator status information in memory of TOR switch 16A or externally. TOR switch 16A may store visual indicator status information that includes information regarding the configuration of virtual visual indicators that are representative of the status of components of TOR switch 16A, such as the mapping of the state of a corresponding component of TOR switch 16A and the color or other characteristic of a virtual visual indicator associated with the corresponding component.

In some examples, TOR switch 16A may provide visual indicator status information to a user (508). For example, TOR switch 16A may receive a request for the visual indicator status information via a command line interface of TOR switch 16A and/or another device, such as a user device of an administrator, and outputs the visual indicator status information of TOR switch 16A.

In some examples, controller 24 may obtain visual indicator status information of TOR switch 16A via a poll from controller 24 to TOR switch 16A (510). In some examples, TOR switch 16A may periodically export the visual indicator status information to controller 24 (512). For example, TOR switch 16A may periodically export the visual indicator status information to controller 24 according to a schedule (e.g., after a given period of seconds, minutes, hours, etc.).

Controller 24 generates a virtual representation of a visual indicator based on visual indicator status information (514). For example, controller 24 may generate a GUI including a graphical representation of a visual indicator for a corresponding component of TOR switch 16A to indicate the state of the corresponding component, where the virtual visual indicator for the corresponding component displays one or more colors and/or one or more animations (e.g., blinking, changing colors, etc.) to indicate the state of the corresponding component. In an example, controller 24 receives visual indicator status information that includes information indicative of a visual indicator for an interface of TOR switch 16A that is in a major alarm state. In this example, controller 24 generates a virtual representation of the visual indicator for the interface of TOR switch 16A having a red color and/or an animation (e.g., blinking). The visual indicator may be overlayed at a location of the interface in a visual representation of TOR switch 16A.

Controller 24 outputs a GUI to a display device (516). In some examples, an application executed by controller 24 may process a request to display a representation of TOR switch 16A, generate a GUI that includes the representation of TOR switch 16A and one or more virtual visual indicators of TOR switch 17A, and output the GUI to a display device of a user device and/or a device connected to controller 24.

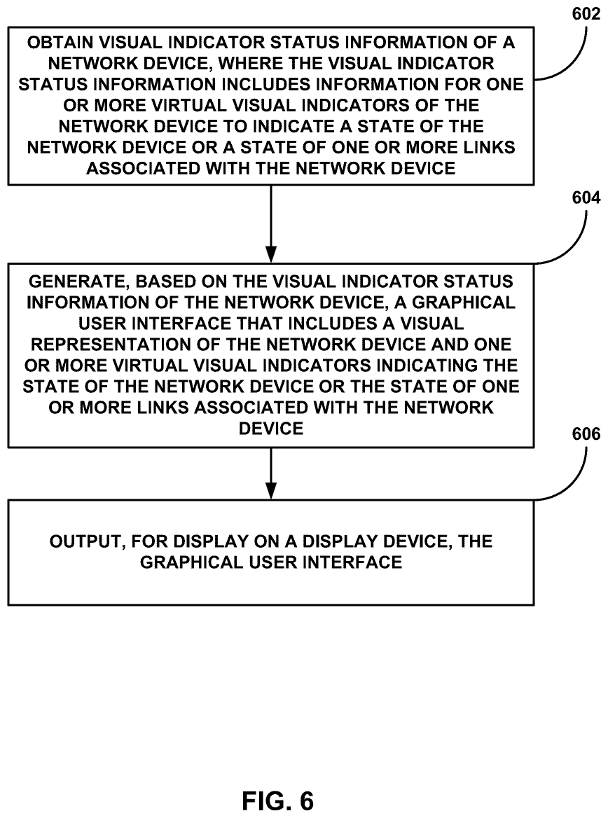

FIG. 6 is a flow diagram illustrating another example operation for providing a graphical user interface including virtual visual indicators, in accordance with one or more techniques in this disclosure. For the purposes of clarity, FIG. 6 is described in the context of FIG. 1.

A controller, such as controller 24, obtains visual indicator status information of a network device, such as TOR switch 16A, where the visual indicator status information includes information for one or more virtual visual indicators of TOR switch 16A to indicate a state of TOR switch 16A or a state of one or more links associated with TOR switch 16A (602). Controller 24 may obtain the visual indicator status information from TOR switch 16A by polling TOR switch 16A or TOR switch 16A may periodically provide the visual indicator status information to controller 24. Controller 24 may obtain visual indicator status information that includes a mapping of colors and/or characteristics (e.g., blinking) of virtual visual indicators of TOR switch 16A to the state of a corresponding link or component of TOR switch 16A, such as the state of a power supply, the state of a fan, the state of an interface card, the overall state of TOR switch 16A, and/or other components. In some examples, controller 24 may obtain state information that includes information regarding the state of components and/or links of TOR switch 16A (e.g., whether the links are in a major or minor alarm state, whether there is no link for a given interface, whether there is activity on a link, etc.) and generate visual indicator status information based on the state information.

Controller 24 generates, based on the visual indicator status information of TOR switch 16A, a graphical user interface (GUI) that includes a visual representation of TOR switch 16A and one or more virtual visual indicators indicating the state of TOR switch 16A or the state of one or more links associated with TOR switch 16A (604). Controller 24 may generate the GUI as including a visual representation of TOR switch 16A and virtual visual indicators corresponding to components of TOR switch 16A that are indicative of a state the corresponding components. In an example, controller 24 generates the GUI as including the virtual visual indicators visually overlaying visual representations of interfaces of TOR switch 16A.

Controller 24 outputs, for display on a display device, the GUI (606). Controller 24 may output the GUI to a display device, such as a user device. Controller 24 may output the GUI via a companion application of controller 24.

The techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such as a processor or an integrated circuit device, such as an integrated circuit chip or chipset. Alternatively, or additionally, if implemented in software or firmware, the techniques may be realized at least in part by a computer-readable data storage medium comprising instructions that, when executed, cause a processor to perform one or more of the methods described above. For example, the computer-readable data storage medium may store such instructions for execution by a processor.

A computer-readable medium may form part of a computer program product, which may include packaging materials. A computer-readable medium may comprise a computer data storage medium such as random access memory (RAM), read-only memory (ROM), non-volatile random access memory (NVRAM), electrically erasable programmable read-only memory (EEPROM), Flash memory, magnetic or optical data storage media, and the like. In some examples, an article of manufacture may comprise one or more computer-readable storage media.

In some examples, the computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache). The code or instructions may be software and/or firmware executed by processing circuitry including one or more processors, such as one or more digital signal processors (DSPs), general purpose microprocessors, application-specific integrated circuits (ASICs), field-programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, functionality described in this disclosure may be provided within software modules or hardware modules.

What is claimed is:

1. A computing system, comprising:
memory; and
one or more programmable processors in communication with the memory, wherein the one or more programmable processors are configured to:
obtain visual indicator status information of a network device, wherein the visual indicator status information includes information for one or more virtual visual indicators of the network device to indicate a state of the network device or a state of one or more links associated with the network device;
generate, based on the visual indicator status information of the network device, a graphical user interface that includes a visual representation of the network device and one or more virtual visual indicators indicating the state of the network device or the state of one or more links associated with the network device; and
output, for display on a display device, the graphical user interface.

2. The computing system of claim 1, wherein the network device does not include visual indicators that are physically present on the network device.

3. The computing system of claim 1, wherein to generate the graphical user interface, the one or more programmable processors are further configured to:
generate a visual representation of a rack of one or more network devices including the network device, wherein each of the one or more network devices of the rack includes one or more virtual visual indicators to indicate a state of a corresponding network device or a state of one or more links associated with the corresponding network device.

4. The computing system of claim 1, wherein the visual indicator status information comprises a first visual indicator status information for one or more virtual visual indicators of the network device to indicate a first state of the network device or a first state of one or more links associated with the network device, wherein the graphical user interface comprises a first graphical user interface, and wherein the one or more programmable processors are further configured to:
obtain second visual indicator status information of the network device for one or more virtual visual indicators of the network device to indicate a second state of the network device or a second state of one or more links associated with the network device;
generate, based on the second visual indicator status information, a second graphical user interface that includes the visual representation of the network device and one or more virtual visual indicators indicative of the second state of the network device or the second state of one or more links associated with the network device; and
output, for display on the display device, the second graphical user interface.

5. The computing system of claim 1, wherein the one or more programmable processors are further configured to:
receive, from a user device, a request to view one or more visual indicators of the network device;
output, for display on the user device, the graphical user interface.

6. The computing system of claim 1, wherein the visual indicator status information comprises a particular color corresponding to a particular status of the network device or a particular status of a corresponding link of the one or more links of the network device.

7. The computing system of claim 1, wherein the one or more programmable processors are further configured to:
output a textual representation of a state of the one or more virtual visual indicators of the network device via a command line interface.

8. The computing system of claim 1, wherein the visual indicator status information comprises information regarding a status of an interface associated with the network device.

9. The computing system of claim 1, wherein the visual representation of the network device includes a representation of a first side of the network device and a representation of a second side of the network device, wherein the first side of the network device comprises a front panel of the network device and wherein the second side of the network device comprises a back panel of the network device.

10. A method, comprising:
obtaining, by a computing system, visual indicator status information of a network device, wherein the visual indicator status information includes information for one or more virtual visual indicators of the network device to indicate a state of the network device or a state of one or more links associated with the network device;
generating, by the computing system based on the visual indicator status information of the network device, a graphical user interface that includes a visual representation of the network device and one or more virtual visual indicators indicating the state of the network device or the state of one or more links associated with the network device; and
outputting, by the computing system and for display on a display device, the graphical user interface.

11. The method of claim 10, wherein the network device does not include visual indicators that are physically present on the network device.

12. The method of claim 10, wherein generating the graphical further comprises:
generating a visual representation of a rack of one or more network devices including the network device, wherein each of the one or more network devices of the rack includes one or more virtual visual indicators to indicate a state of a corresponding network device or a state of one or more links associated with the corresponding network device.

13. The method of claim 10, wherein the visual indicator status information comprises a first visual indicator status information for one or more virtual visual indicators of the network device to indicate a first state of the network device or a first state of one or more links associated with the network device, wherein the graphical user interface comprises a first graphical user interface, and further comprising:
obtaining, by the computing system, second visual indicator status information of the network device for one or more virtual visual indicators of the network device to indicate a second state of the network device or a second state of one or more links associated with the network device;
generating, by the computing system and based on the second visual indicator status information, a second graphical user interface that includes the visual representation of the network device and one or more virtual visual indicators indicative of the second state of the network device or the second state of one or more links associated with the network device; and
outputting, for display on the display device, the second graphical user interface.

14. The method of claim 10, further comprising:
receiving, by the computing system and from a user device, a request to view one or more visual indicators of the network device; and
outputting, by the computing system and for display on the display device, the graphical user interface.

15. The method of claim 10, wherein the visual indicator status information comprises a particular color corresponding to a particular status of the network device or a particular status of a corresponding link of the one or more links of the network device.

16. The method of claim 10, further comprising:
outputting, by the computing system, a textual representation of a state of the one or more virtual visual indicators of the network device via a command line interface.

17. The method of claim 10, wherein the visual indicator status information comprises information regarding a status of an interface associated with the network device.

18. The method of claim 10, wherein the visual representation of the network device includes a representation of a first side of the network device and a representation of a second side of the network device, wherein the first side of the network device comprises a front panel of the network device and wherein the second side of the network device comprises a back panel of the network device.

19. Non-transitory computer-readable media that includes instructions configured to cause processing circuitry to:
obtain visual indicator status information of a network device, wherein the visual indicator status information includes information for one or more virtual visual indicators of the network device to indicate a state of the network device or a state of one or more links associated with the network device;
generate, based on the visual indicator status information of the network device, a graphical user interface that includes a visual representation of the network device and one or more virtual visual indicators indicating the state of the network device or the state of one or more links associated with the network device; and
output, for display on a display device, the graphical user interface.

20. The non-transitory computer-readable media of claim 19, wherein the network device does not include visual indicators that are physically present on the network device.
